(19) United States
(12) Patent Application Publication
(10) Pub. No.: US 2018/0162498 A1
(43) Pub. Date: Jun. 14, 2018

(54) Illumination System for a Watersport Board

(71) Applicants: Kimberly Harrison, Martinez, CA (US); Michael Thielvoldt, Martinez, CA (US)

(72) Inventors: Kimberly Harrison, Martinez, CA (US); Michael Thielvoldt, Martinez, CA (US)

(21) Appl. No.: 15/373,455

(22) Filed: Dec. 8, 2016

(51) Int. Cl. B63B 45/04; F21V 31/00; F21S 9/02; F21V 23/04; F21V 23/06; B63B 35/79

(52) U.S. Cl. CPC B63B 45/04; F21V 31/005; F21S 9/02; F21W 2101/04; F21V 23/06; F21V 23/0464; B63B 35/793; F21V 23/04

(57) ABSTRACT

A system for illuminating a class of watersport boards. The system includes a light on the top of the board and a light-transmitting fin on the underside of the board. The board-top light and the light-transmitting fin are fastened together with fasteners that pass through the board. The board-top light contains a battery and energizes the light-transmitting fin through an energy-coupling. Electrically conductive paths and translucent channels are both discussed as energy couplings. An inductive charging connector is provided for charging the battery. Remaining service-time is reported to a user based on battery charge. Additional sensors, such as light sensors, and a microcontroller allow the unit to turn on automatically when ambient light falls below a programmed threshold.

14

### CROSS REFERENCE

This application claims the benefit of U.S. Provisional Application No. 62/264,839, filed Dec. 8, 2015, which application is incorporated herein by reference.

### FIELD OF THE INVENTION

This invention relates generally to illumination systems for sporting equipment, and, in particular, to modular illumination systems for the aesthetic and functional use of watersports boards such as kiteboards, wakeboards, paddleboards and waterskis in low-light conditions.

### BACKGROUND OF THE INVENTION

Several watersport activities allow a rider to ride the surface of a body of water atop a board that the rider stands on, for example, kiteboarding, wakeboarding, surfing and windsurfing. These sports, hereafter referred to as “water boardsports” are conventionally enjoyed in the daytime, but favorable conditions and time constraints sometimes compel sportsmen and sportswomen to ride after sundown.

However, many water board-sports involve the rider being separated from the board when he or she falls. As the light fades, it becomes more difficult to find a floating board and the risk of being struck by boats or other sportsmen and sportswomen greatly increases. For many people, the prospect of riding at night is not attractive enough to warrant the purchase of boards that are purpose-built for night riding, but such a rider may be compelled to upgrade their non-illuminated boards in order to protect themselves and their equipment.

To illuminate a board inexpensively, some riders will attach chemiluminescent glow sticks or other inexpensive light sources to their boards. While this can be helpful if the board remains upright, the board can also flip upside down and hide the light when the rider falls. When the light source is under-water, turbidity in the water and internal reflection can make the emitted light invisible over a short distance. Attaching the light source to a tether may allow the light source to move out from underneath the board, but does not guarantee this, and also allows the light source to strike the rider and drag in the water, creating a nuisance and potentially adding drag. Attaching a glow-stick or other generic light source to the bottom of a board almost invariably increases the hydrodynamic drag of the board, compromising the board's performance.

Water boardsports also generally require riders to have their equipment in a state of readiness hours or days before they actually ride. The wind or wave conditions, can appear suddenly and last for a short time, leaving little time to prepare before the rider begins the activity. For wakeboarding, riders often must drive for hours to the lake or river where the riding happens, meaning that the equipment must be made ready before the rider leaves home.

Accordingly, there is a need for an illumination device that can be easily installed on non-illuminated watersport boards that provides significant light both above and below the board without disrupting the hydrodynamic performance of the board, and which makes a floating board easily visible to an observer swimming a distance away. Additionally, there is a need for such an illumination device that can emit a sustained light intensity on both sides of the board when switched on, but which may be prepared hours or weeks before the activity takes place and can be switched off to maintain a state of readiness when the board is not in use.

### SUMMARY OF THE INVENTION

The present invention is directed to a system that combines a battery-powered board-top light and a light-emitting fin, which are affixed to each other with fasteners that extend through holes in a watersport board, where the board-top light powers the light-emitting fin.

The threaded fasteners may also convey power from the top module to the fin module, and the system may additionally comprise advantageous elements such as light sensors, calculation and indication of sustainable on-time, various colors, corrosion-inhibiting sealing surfaces, multiple illumination states, favorable luminous intensity distributions and robust sealing strategies.

In a further preferred embodiment, an inductive charging module may be provided to recharge the battery using inductive coupling so as to avoid the use of connectors with metallic contacts that may be susceptible to corrosion. The inductive charging module may preferably feature structures or geometry that retain a charging connector in an aligned position with a receiver coil.

Various objects, features, aspects, and advantages of the present invention will become more apparent from the following detailed description of preferred embodiments of the invention, along with the accompanying drawings in which like numerals represent like components.

### INCORPORATION BY REFERENCE

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be independently confirmed.

### BRIEF DESCRIPTION OF THE SEVERAL VIEWS OF THE DRAWING

FIG. 1 is a perspective view of a rider using a board with a preferable embodiment of an illumination device

FIG. 2 is schematic view of a first embodiment of an illumination device showing geometry and sub-systems hidden in FIG. 1.

FIG. 3 is schematic view of a second embodiment of an illumination device showing some geometry and sub-systems hidden in FIG. 1.

FIG. 4 is a partial section view of the first embodiment of an illumination system showing some geometry and sub-systems hidden in FIG. 2

FIG. 5 is a partial section view of the second embodiment of an illumination system showing some geometry and sub-systems hidden in FIG. 2.

FIG. 6 is a schematic of the electrical components and circuitry within an illumination system of the second embodiment.

FIG. 7 is a flowchart of a program that governs the behavior of a preferable board-top light.

FIG. 8 is a partially sectioned view of a preferable battery charging arrangement.

FIG. 9 is a polar diagram showing a preferable distribution of luminous intensity.

### DETAILED DESCRIPTION

While several preferred embodiments of the invention are shown and described herein, such embodiments are provided by way of example only. Numerous variations, changes, and substitutions will now occur to those skilled in the art without departing from the invention. It should be understood that various alternatives to the embodiments of the invention described herein may be employed in practicing the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

### Terminology

Watersport board: a thin, substantially flat, water-impervious object that supports a rider by generating hydrodynamic lift when it is propelled across the surface of a body of water. A watersports board is not self-propelled, and has a top surface, bottom surface, and edges, but does not have tall side-walls, as does a boat or canoe. A watersports board's surfaces may not be exactly flat, commonly including one or more modest curvatures such as rocker and camber. Examples include surfboards, wakeboards, kiteboards, and sailboards.

Board: watersport board

Top: taken in the reference frame of the watersport board, indicating the broad surface of the watersport board facing away from the water and designed to contact the rider.

Bottom: taken in the reference frame of the watersport board, indicating the broad surface of the watersport board designed to interact with the water.

Fin: A thin, elongate, streamlined structure that extends from an object and guides the movement of that object through water.

Switchably connected: configured to permit an exchange of power, data, or control signals, but wherein this exchange may be repeatedly interrupted and re-established.

Electrically Connected: referring to two devices that are configured to exchange power, data, or signals. This term does not preclude additional devices situated between the two connected devices in the power/data/signal path.

Sandwiched: describing a physical arrangement in which a first and second object are situated directly opposite to each other with at least a portion of a third object between the first and second objects.

Push-button: an electro-mechanical device that converts a physical force into an electrical control signal.

Non-directional: not having a dominant directionality.

Sealing face: a physical surface that presses against another physical surface and in doing so forms a barrier to fluids.

Substantially within: at least partially within, but not necessarily wholly within.

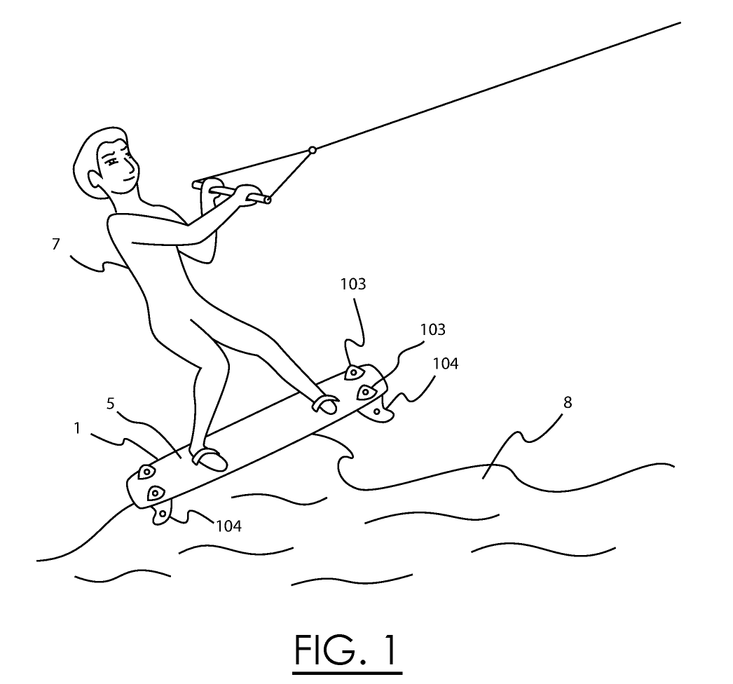

FIG. 1: Use Scenario

FIG. 1 generally depicts one anticipated use of a watersport board 1 with attached illumination system comprising a board-top light 103 and translucent fin 104 according to a preferred arrangement. The board-top light 103 is attached to the top side 5 of the board 1. The top side 5 of the board 1 would be stood on by a rider 7 travelling along the surface of the water 8. The translucent fins 104 are attached to the watersport board 1 such that they protrude into the water 8 below the bottom side (not shown) of the watersport board 1. The board-top light 103 and translucent fin 104 are arranged together, so that one board-top light 103 and one translucent fin 104 together sandwich the watersport board 1 between them, and are bound together by fasteners that pass through the watersport board 1. The general design of the watersport board 1 has similarities to existing wakeboards such as that shown in U.S. Pat. No. 6,461,210, Incorporated herein in its entirety.

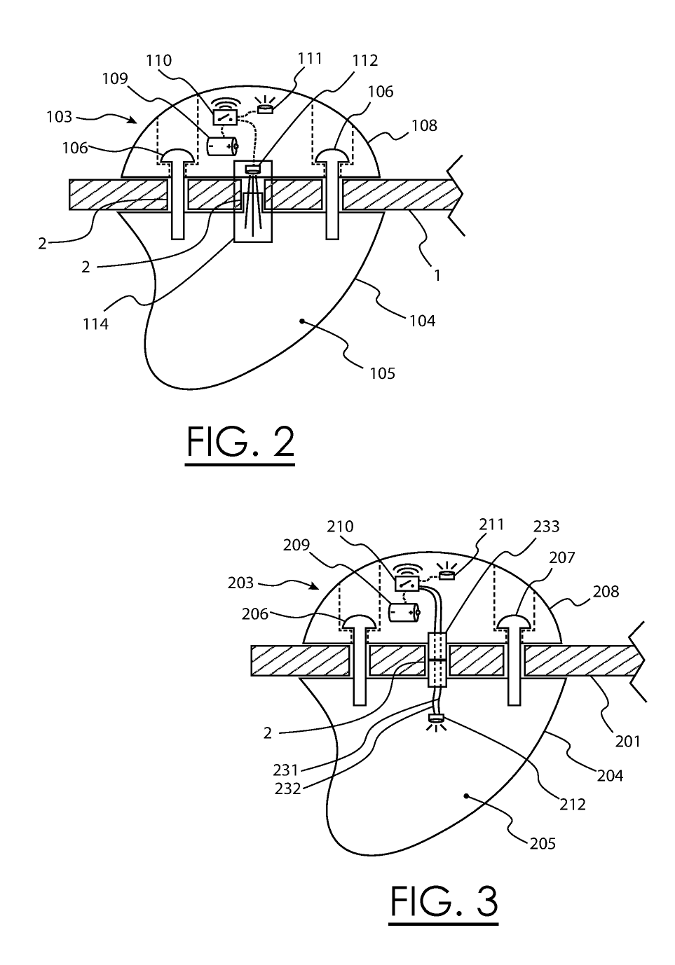

FIG. 2: First Preferred Illumination Scheme

FIG. 2 illustrates a first preferred arrangement of the illumination system on a watersport board 1 which includes at least two holes that each extend completely through the top side 5 and the bottom side 6 of the watersport board 1. The illumination system comprises a board-top light 103 and translucent fin 104 that sandwich the watersport board 1 and are mechanically fastened together by at least one threaded fastener 106 that passes through a hole 2 in the watersport board 1. The board-top light 103 is enclosed by a translucent waterproof container 108 which protects the internal components from ambient conditions and external forces, and which also determines the shape of the board top light 103. The board-top light 103 further comprises a battery 109 and a first light-emitting component 111, which are switchably connected by an interface switch 110 that is disposed at least partially within the waterproof container 108. A light-emitting component can be any electronic component that emits visible light when energized, for example an LED. The interface switch may be a push-button switch, slide-able switch, knob, magnetic switch or other contact or non-contact switch. When energized by the battery 109, the first light-emitting component 111 emits light which is visible to onlookers through the waterproof container 108.

The translucent fin 104 comprises a translucent body material 105.

The illumination system further comprises an energy transfer coupling 114 that transfers energy from the battery 109 in the board-top light 103 to the translucent fin 104, thereby illuminating the translucent fin 104. The energy transfer coupling 114 may be energized or de-energized by the interface switch 110, thus allowing a user 7 to begin or cease emission of light from both the board-top light 103 and the translucent fin 104 simultaneously. Energy can be conveyed from the board-top light 103 to the translucent fin 104 through the watersport board 1 in many ways, for example fluorescence of the fin caused by emission of UV light from the board-top light 103. FIG. 2 shows one possible embodiment of the energy transfer coupling 114 comprising a second light-emitting component 112 disposed within the board top light 103 and substantially aligned with a third hole 2 in the watersport board 1 so that the light from the second light emitting component is directed toward the translucent fin 104, thus illuminating the translucent fin 104.

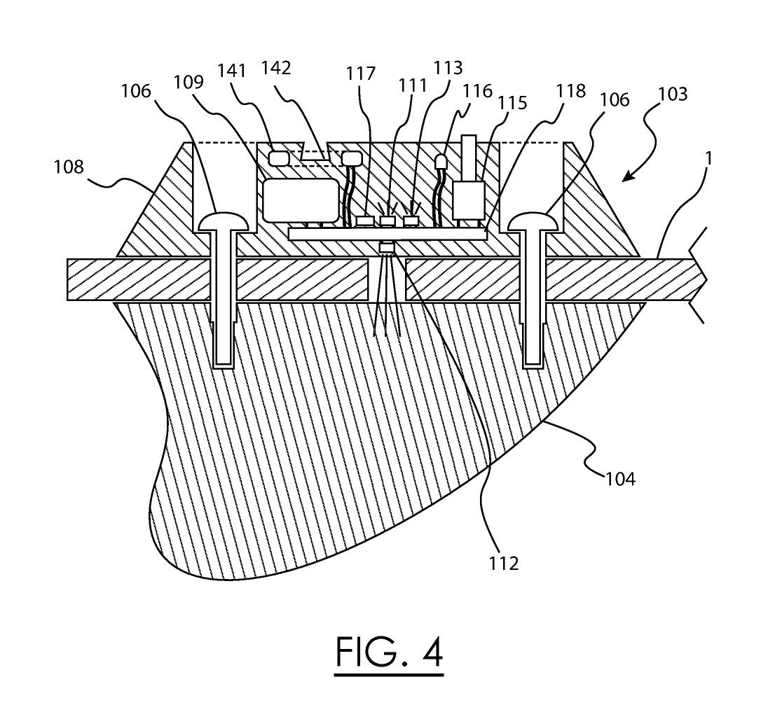

### FIG. 4: Control and Charging

In another preferred embodiment of the illumination system, the addition of a microcontroller 117 allows for more features regarding control and charging. A program 260 stored in the microcontroller's program memory allows the microcontroller 117 to control the transfer of energy between the energy storage elements and the light-emitting components in response to input from a sensor or modulation of a switch. There are a variety of sensors that would be desirable for an interactive illumination system, for example a light sensor. FIG. 4 illustrates one possible embodiment of the illumination system with a similar arrangement to the embodiment shown in FIG. 2. In this embodiment, the board-top light 103 further comprises a circuit board 118 mounted with the battery 109, a first light-emitting component 111, a second light-emitting component 112, a third light-emitting component 113, an ambient light sensor 116, a push-button 115, and a microcontroller 117. In this embodiment, the microcontroller 117 responds to an electrical signal from the push-button 115 by energizing or de-energizing the light-emitting components. The first light-emitting component 111 illuminates the board-top light 103, the second light-emitting component 112 illuminates the translucent fin 104, and the third light-emitting component 113 emits a range of colors distinguishable from those emitted by the first light-emitting component 111. The microcontroller 117 can also monitor the charge on the battery 109, calculate the time remaining on the current battery charge, and report the remaining time through a light display based on color, brightness or pattern. The microcontroller can also modulate the light based on the ambient light sensor 116. For example, the microcontroller 117 could energize the lights when the ambient light falls below a certain threshold.

In some embodiments of the illumination system, the battery 109 is non-removeable and must be recharged. There are many advantages to using a non-removeable battery, for example environmental friendliness, lower cost to the user in the long-term and a waterproof housing that does not require repeatable sealing mechanisms. Any method for driving a current could be used to recharge a non-removeable battery, for example a plug with conductive elements or inductive charging. FIG. 4 shows an embodiment with an inductive receiver coil 141 and connector retainer 142 for mechanically retaining a powered inductive charger.

### FIG. 3: Second Preferred Illumination Scheme

In another preferred embodiment, a light-emitting fin 204 comprises a fin body material 205 and a second light-emitting component 212, which can be energized to illuminate the fin. A board-top light 203 comprises a waterproof container 208, battery 209, first light-emitting component 211, and interface switch 210. The board-top light 203 and light-emitting fin 204 sandwich the watersport board 201, and are in physical contact and mechanically bound together by at least two fasteners (a first threaded fastener 206 and a second threaded fastener 207) that pass through holes 2 in the watersport board 201.

In this embodiment, the second light-emitting component 212 in the light-emitting fin 204 is switchably connected to the battery 209 in the board-top light 203 through a first electrically-conductive path 231 and a second electrically-conductive path 232, so that the battery 209 energizes the second light-emitting component 212 to emit light. The interface switch 210 can be arranged to energize and de-energize both the first light-emitting component 211 and the second light-emitting component 212 in response to modulation of the interface switch 210.

The first electrically-conductive path 231 and second electrically-conductive path 232 can take many forms, for example wires passing through a hole 2 in the watersport board 201, energy passing through conductive fasteners or an inductive coupling. FIG. 3 shows one possible embodiment in which the first electrically conductive path 231 and second electrically conductive path 232 are wires which pass through a third hole 2 in the watersport board 201 and switchably connect the second light emitting component 212 to the battery 209 using a through-board connector 233 to illuminate the light emitting fin 204.

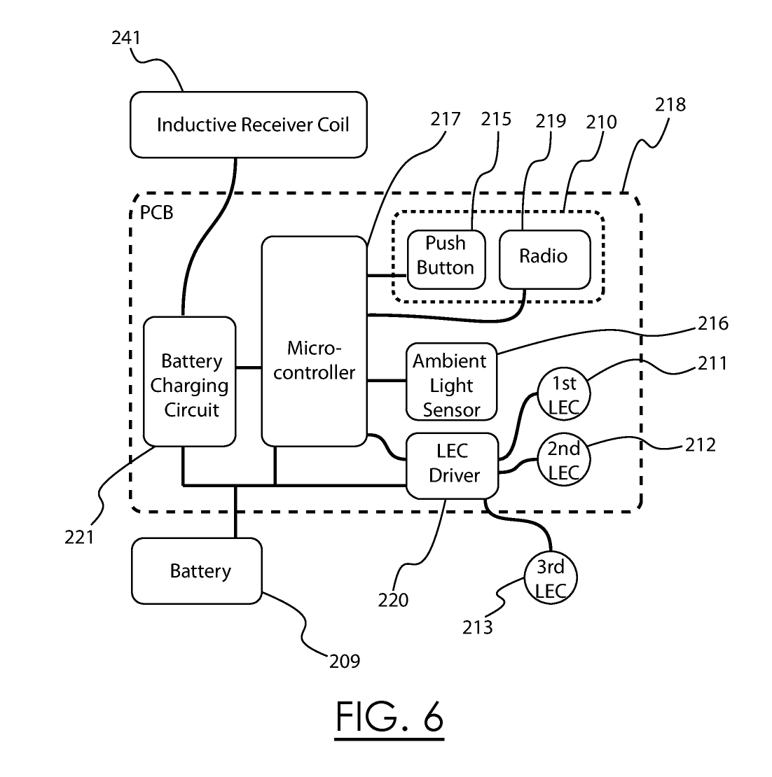

### FIG. 6: Illumination System Electrical Diagram

FIG. 6 shows a preferred schematic of the circuitry within the present illumination system. The shown components would commonly be connected by conductors on a printed circuit board 218 but may also be connected by wires or other conductive components. In this embodiment, the first, second and third light-emitting components 211, 212 and 213, respectively, are preferably light emitting diodes owing to their efficiency, small size, low operating voltages and availability in a variety of colors, but may alternatively be any reasonably small electrically-powered light source including, for example, cold cathode fluorescent lamps, gas discharge tubes or filament bulbs. In this embodiment, the light-emitting component driver 220 modulates energy to the light-emitting components 211, 212 and 213 in response to the microcontroller 217. The microcontroller 217 monitors the battery 209 and controls the battery charging circuit 221 which is preferably connected to an inductive receiver coil 241 but may also be connected to some other power source that can be used to charge the battery 209.

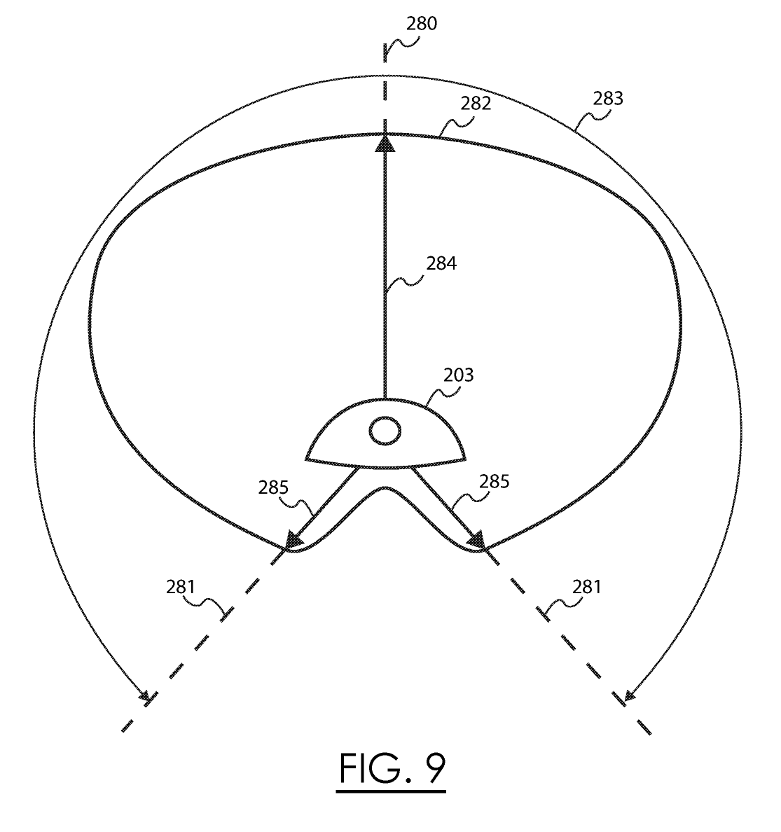

### FIG. 9: Illumination Intensity Distribution

When a watersports board is lost in low light during a watersports activity, the owner must quickly locate his or her board. The owner may swimming in the water, and therefore may be at eye level with his or her board. Further difficulty is introduced because, once lost, the owner cannot control the orientation of their board in the water. Therefore, it is important that the three-dimensional distribution of the light being emitted by the present illumination system is as large as possible. The half power beam angle is well known in the art of light emitting devices, and is a measurement of the spatial distribution of luminous intensity around a light source with respect to the geometric center axis of the light emitting device. As shown in FIG. 9, the luminous intensity curve 282 can be drawn around the board-top light 203 in polar coordinates, and represents the luminous intensity at different viewing angles. The center line of intensity 284 is defined as the luminous intensity along the center axis 280, which is determined by the geometry of the board-top light 203. The magnitude of the line of half intensity 285 is half of the center line intensity 284 and lies along the half-power direction 281, which is the direction at with the luminous intensity is half of that observed at the center axis 282. The half-power beam angle 283 is defined by the half-power direction 281, as shown. The present illumination system comprises a half power beam angle 283 of at least 180 degrees.

### Microcontroller

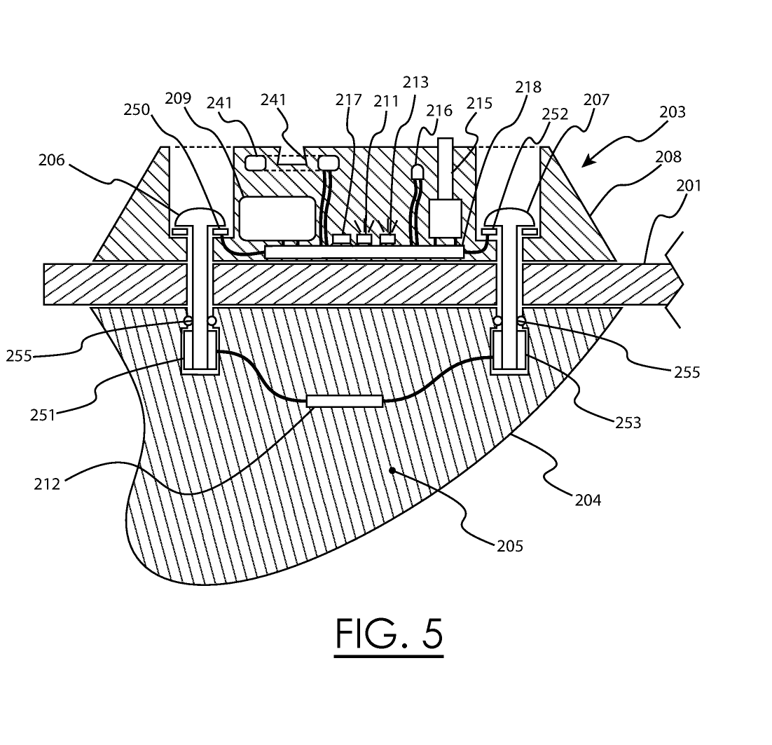

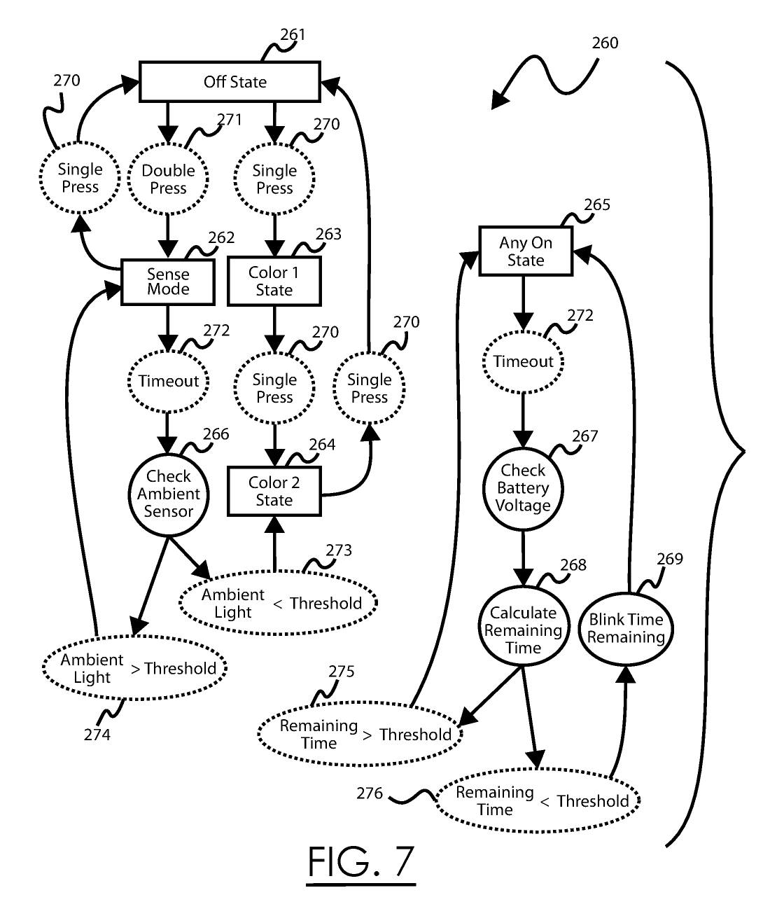

A microcontroller is shown in FIG. 4 as 117, and in FIG. 5 as 217. The microcontroller provides many design opportunities for enhancing the function of the light system. FIG. 7 shows one preferred structure of a program 260. Various modulation patterns of the interface switch 210, 110 are recognized by the microcontroller, in this embodiment, the microcontroller recognizes a single press 270, and a double press 271. Various color states are also included as part of the program, shown as color state 1 263 and color state 2 264. These are activated from the off state 261 with a single press event 270. In this manner, various colors may be selected using the interface switch.

### Battery-Time Indication

The microcontroller 117, 217 may also be used to report the amount of time that the light can be sustained. This is a particularly important piece of information to a rider riding in the dark. An unexpected exhaustion of the light system battery could create a hazardous situation. Further, a rider will require time to reach safety before battery exhaustion occurs. The various illumination states such as 263 and 264 may consume the battery energy at different rates, so a calculation of time may be advantageous over a reporting of battery level. As one implementation, FIG. 7 shows that in any on state 265, which in this case would correspond to either color state 1 263 or color state 2 264, the microcontroller waits for a timeout event 272 and subsequently checks the battery voltage 267 then calculates 268 the amount of time the battery will sustain the present color state. One way to achieve this is by dividing the remaining charge-level of the battery in mAh by the current being consumed in the present illumination state in mA to yield hours remaining. Other strategies also exist, including maintaining historical data of durations vs voltage for each illumination state. In the present embodiment, the microcontroller then compares the result of the previous calculation to a threshold. In the condition 276 that the remaining time is less than a threshold amount of time, the microcontroller will indicate the remaining time 269. In this embodiment, we suggest blinking at least one of the light-emitting components once for each unit-of-time remaining. In this way, a rider will be alerted of when the battery is nearing exhaustion in terms of time remaining, and will know how much time remains. In the condition 275 that the remaining time is more than a threshold amount of time, the microcontroller does nothing, and thereby avoids annoying the rider when plenty of time remains.

### Push-Button

FIG. 4 shows a push button 115 as a particular implementation of the interface switch FIG. 2, 110. Similarly, FIG. 5 shows a push button 215 as a particular implementation of the interface switch FIG. 3, 210. A push button has particular applicability in this context because a rider may require a simple interface that does not require tools to modulate. However, in concert with a button, a radio interface, FIG. 6, 219 may be an advantageous addition to the interface switch, as it would permit synchronization of light patterns, remote activation, and potentially re-programming of the microcontroller.

Conduction through Threaded Fasteners

FIG. 5 shows a detailed section view of the second embodiment. Here we see that the conductive paths 231, 232, may utilize the threaded fasteners 206, 207, to convey electrical current to the second light-emitting component 212. In order to achieve this, electrical contacts 250, 252 may extend from inside the waterproof container 208 to contact the fasteners 206, 207. Additional electrical contacts 251, 253 inside the fin may electrically connect the fasteners to the second light-emitting component 212. Contacts of various geometries and materials would be suitable. Preferable contact designs utilize the binding force of the fastener in making reliable electrical contact. Contacts that utilize other techniques for making electrical contact such as spring force and loose conductive media such as conductive greases are also contemplated and can be advantageously combined or substituted as the design details dictate.

Sealing Face between Fin and Fasteners

A sealing face 255 may be advantageously incorporated in the design to mitigate corrosion of the threaded fasteners 206, 207 and the electrical contacts 251, 253. It is well-known that watersport boards are used in corrosive environments. Electrically energized metals are particularly susceptible to accelerated corrosion in the presence of salt-water. While the fasteners may be replaced, the contacts 251, 253 may not be replaceable, so their protection may be highly advisable. Sealing face 255 may be the surface of an elastic part, such as a rubber o-ring, or it may be any geometry that fits against the threaded fasteners without gaps. One successful method of constructing this sealing face is to mold the fin with a threaded fastener held inside the mold. The geometry of the threads will be accurately captured in the fin body material 205. If the body material is hydrophobic or water repellant, water ingress may be blocked with this manner of construction.

### Colors and 3rd Light-Emitting Component

In addition to the first 211 and second 212 light-emitting components, a third light-emitting component 213 of a different light color than 211 is shown connected to the circuit board, 218. Light-emitting component 211 gives the board-top light the ability to produce multi-color lighting and color mixing. Of course, this strategy is not limited to only one additional light-emitting component. A fourth, fifth, sixth, and more light-emitting components may be added to achieve a number of advantages including, but not limited to: color depth, greater brightness, more uniform light distribution, patterns. The availability of multiple colors is particularly helpful for producing indications for the rider 7 of the light's status. For example, a low-battery warning may be communicated with illumination of a red light-emitting component.

All of the above advantages apply as well to the first embodiment, so FIG. 3 shows third light-emitting component, 113.

### Light Sensor/Light Sensing Mode

FIG. 5 shows an ambient light sensor 216 electrically connected to the circuit board 218. As is well-known to kiteboarders, unfortunate circumstances can force a rider to abandon his/her board for one or more hours. The ambient light sensor 216 may be advantageously used to automatically turn on the light system when darkness falls. This can greatly aid an unfortunate rider in finding his/her board. In order to utilize this sensor 216, the microcontroller 217 should be electrically connected to the sensor 216, as shown in FIG. 6 and programmed to make sensible use of it. Referring to FIG. 7, a light-sensing mode 262 is recommended. Light-sensing mode may be entered by modulating the interface switch in a particular way, for example by a double-press 271, and may be exited in a similar manner, for example, with a single-press 270. During execution of the light-sensing mode 262, the microcontroller repeatedly takes the action of checking the sensed ambient light level 266, for a condition of either low ambient light 273, or high ambient light 274 at the expiration 272 of a certain time. If ambient light is high, condition 274, execution returns to the light-sensing mode 262. If ambient light is low, condition 273, the microcontroller 217 will enter a state with the lights on, such as color state 2 264, thereby making the board more visible and aiding the rider 7. Of course, innumerable variations to this portion of the program structure could be implemented, while still achieving the described function of the ambient light sensor 216.

The ambient light sensing functionality described above, applies as well to the first embodiment as it does to the second. FIG. 4 therefore shows ambient light sensor 116, which is used in the same manner as 216.

### Inductive Charging Connector

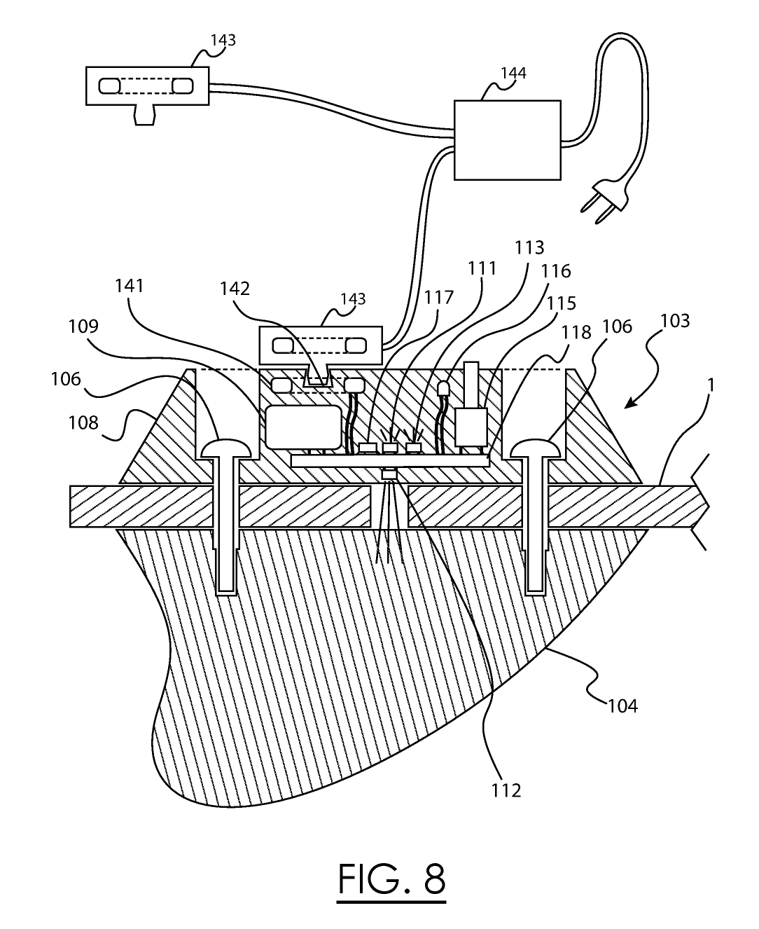

FIG. 8 shows a preferable charging connector 143 removably connected to the board-top light 103 and electrically energized by electrical power splitter 144. In this embodiment, the charging connector 143 engages with a connector retainer 142, which, as mentioned, provides a retaining force to the inductive charging connector. The inductive charging connector 143 also inductively couples to the inductive receiver coil 141, driving a current in the receiver coil 141, which in turn energizes the battery charging circuit, which is shown in FIG. 6 as 221. The connector retainer 142 may also provide aid in aligning the inductive charging connector 143 over the inductive receiver coil 141 to improve energy transmission efficiency. The connector retainer 142, may be a mechanical retainer that acts through friction, elastic deformation of an interlocking geometry, or it may be a magnet. The connector retainer is shown in FIG. 5 as 242. The electrical power splitter 144 simply energizes multiple charging connectors simultaneously. It may have the capacity to energize, 2, 3, 4, 5, 6, or any number of charging connectors. The splitter thereby permits multiple light system batteries 209 109 to be charged simultaneously, saving time.

We claim:

1. A light system for illuminating a watersport board including at least two holes that each extend through the board's top and the board's bottom surface, the light system comprising:
a board-top light comprising:
a waterproof container having an exterior surface,
a battery disposed within the waterproof container,
a first light-emitting component disposed within the waterproof container and switchably connected to the battery,
an interface switch disposed at least partially within the waterproof container and energized by the battery,
a translucent fin comprising a translucent body material;
at least one threaded fastener;
an energy transfer coupling that transfers energy from the board-top light to the translucent fin;
the board-top light and the translucent fin being spatially oriented so that they sandwich a section of the watersport board;
wherein the threaded fastener is in binding physical contact with both the board-top light and the translucent fin through the watersport board;
wherein the translucent fin is illuminated by the transference of energy from the battery to inside the fin by the energy transfer coupling through at least one hole in the watersport board;
the interface switch being configured to cause the first light-emitting component and the energy transfer coupling to be alternately energized and de-energized by the battery,
whereby both the board-top light and the translucent fin will alternately begin emitting light and cease emitting light in response to modulation of the interface switch.

2. The light system of claim 1, the energy transfer coupling comprising a second light emitting component disposed within the board-top light and substantially aligned with one of the holes in the watersport board, wherein light from the second light emitting component is directed into the fin's translucent body material through the hole in the watersport board.

3. The light system of claim 2 wherein the interface switch comprises a push-button, and wherein the board-top light further comprises a microcontroller that is electrically connected to the push-button, and a program that is stored in the microcontroller's program memory, wherein the microcontroller controls current flow between the battery and the first and second light-emitting components in response to modulation of the push-button according to the program.

4. The light system of claim 3 further comprising:
a third light-emitting component disposed within the waterproof container of the board-top light, which emits light of a different color than the first light-emitting component, the microcontroller being configured to energize and de-energize the third light emitting component independently from the first light-emitting component;
a plurality of illumination states that produce distinct colors that are selected by modulating the interface switch, whereby a desired light color is selected by modulating the interface switch.

5. The light system of claim 4 wherein the microcontroller monitors the battery voltage and calculates the amount of time that the battery will sustain the selected illumination state, and wherein the board-top light visibly indicates by light color, pattern or both, the amount of time that the battery will sustain the present illumination state.

6. The light system of claim 5 wherein the light emitted by the board-top light is non-directional in that it has a half-power beam angle of at least 180 degrees.

7. The light system of claim 5 further comprising an ambient light sensor connected to the microcontroller, and a light-sensing mode that is implemented in the program, wherein during execution of the light-sensing mode, the microcontroller will energize at least one of the light-emitting components in response to a drop in the sensed ambient light level below a programmed ambient light level.

8. The light system of claim 7 wherein the battery is a non-removable rechargeable battery and further comprising:
a battery charging circuit disposed within the board-top light and connected to the battery,
a connector retainer physically integrated with the board-top light,
an inductive receiver coil electrically connected to the battery charging circuit,
an inductive charging connector,
wherein the inductive charging connector removably physically connects to the connector retainer,
wherein the connector retainer exerts a retention force on the inductive charging connector when the two are physically connected,
and wherein the inductive charging connector inductively couples to the inductive receiver coil, thereby supplying energy to the battery charging circuit when energized and connected to the board-top light.

9. The light system of claim 8 additionally comprising an electrical power splitter that simultaneously energizes a plurality of inductive charging connectors, whereby multiple board-top lights may be simultaneously charged without removing them from the watersport board.

10. A light system for illuminating a watersport board including at least two holes that each extend through the board's top and the board's bottom surface, the light system comprising:
a board-top light comprising:
a waterproof container having an exterior surface,
a battery disposed within the waterproof container,
a first light-emitting component disposed within the waterproof container and switchably connected to the battery,
an interface switch disposed at least partially within the waterproof container and energized by the battery;
a light-emitting fin comprising:
a body material;
a second light-emitting component disposed at least partially within the body material,
a first threaded fastener and a second threaded fastener;
the board-top light and the light-emitting fin being spatially oriented so that they sandwich a section of the watersport board with each of the threaded fasteners being in binding physical contact with both the board-top light and the light-emitting fin through the watersport board;
the light system additionally comprising a first electrically conductive path and second electrically conductive path wherein both paths extend through the watersport board and switchably connect the second light-emitting component to the battery.
the interface switch being configured to cause the first and second light-emitting components to be alternately energized and de-energized by the battery,
whereby both the board-top light and the light-emitting fin will alternately begin emitting light and cease emitting light in response to modulation of the interface switch.

11. The light system of claim 10 wherein:
the first and second threaded fasteners are constructed at least partially of an electrically conductive material;
and wherein the first electrically conductive path comprises: a first electrical contact, the first threaded fastener, and a second electrical contact, the first electrical contact being physically integrated with the board-top light and touching the first threaded fastener, thereby making electrical contact, the second electrical contact being disposed within the light-emitting fin and electrically connecting the first threaded fastener to the second light-emitting component;
and wherein the second electrically conductive path comprises a third electrical contact, the second threaded fastener, and a fourth electrical contact, the third electrical contact being physically integrated with the board-top light and touching the second threaded fastener, thereby making electrical contact, the fourth electrical contact being disposed within the light-emitting fin and electrically connecting the second threaded fastener to the second light-emitting component;
and wherein the light-emitting fin also comprises at least one sealing face that seals against the threaded fastener so that water ingress is prevented at the third and fourth electrical contacts.

12. The light system of claim 11 wherein the sealing face comprises sealing internal threads composed of the fin's body material that match the shape of the threaded fastener's external threads.

13. The light system of claim 10 wherein the interface switch comprises a push-button, and wherein the board-top light further comprises a microcontroller that is electrically connected to the push-button, and a program that is stored in the microcontroller's program memory, wherein the microcontroller controls current flow between the battery and the first and second light-emitting components in response to modulation of the push-button according to the program.

14. The light system of claim 13 wherein the light emitted by the board-top light is non-directional in that it has a half-power beam angle of at least 180 degrees.

15. The light system of claim 13 further comprising an ambient light sensor connected to the microcontroller, and a light-sensing mode that is implemented in the program, wherein during execution of the light-sensing mode, the microcontroller will energize at least one of the light-emitting components in response to a drop in ambient light level below a programmed ambient light level.

16. The light system of claim 14 further comprising:
a third light-emitting component disposed within the waterproof container of the board-top light, which emits light of a different color from the first light-emitting component, the microcontroller being configured to energize and de-energize the third light emitting component independently from the first light-emitting component;
a plurality of illumination states that produce distinct colors that are selected by modulating the interface switch, whereby a desired light color is selected by modulating the interface switch.

17. The light system of claim 16 wherein the microcontroller monitors the battery voltage and calculates the amount of time that the battery will sustain the selected illumination state, and wherein the board-top light visibly indicates by light color, pattern or both, the amount of time that the battery will sustain the present illumination state.

18. The light system of claim 17 wherein the battery is a non-removable rechargeable battery and further comprising:
a battery charging circuit disposed within the board-top light and connected to the battery,
a connector retainer physically integrated with the board-top light,
an inductive receiver coil electrically connected to the battery charging circuit,
an inductive charging connector,
wherein the inductive charging connector removably physically connects to the connector retainer,
wherein the connector retainer exerts a retention force on the inductive charging connector when the two are physically connected,
and wherein the inductive charging connector inductively couples to the inductive receiver coil, thereby supplying energy to the battery charging circuit when energized and connected to the board-top light.

19. The light system of claim 18 additionally comprising an electrical power splitter that simultaneously energizes a plurality of inductive charging connectors, whereby multiple board-top lights may be simultaneously charged without removing them from the watersport board.

20. The light system of claim 19 wherein a solid material fills the space within the board-top light not occupied by other components.
